(19) United States
(12) Patent Application Publication
(10) Pub. No.: US 2013/0220749 A1
(43) Pub. Date: Aug. 29, 2013

(54) FALL-BACK PREVENTION PRESS

(71) Applicant: Christian Stammen, Kaarst (DE)

(72) Inventor: Christian Stammen, Kaarst (DE)

(21) Appl. No.: 13/881,071

(22) PCT Filed: Oct. 26, 2011
(86) PCT No.: PCT/DE11/01897

§ 371 Date: Apr. 23, 2013

(30) Foreign Application Priority Data
Oct. 29, 2010 (DE) 10 2010 049 750.9

(51) Int. Cl. B66C 23/92

(52) U.S. Cl. CPC B66C 23/92
USPC 188/269

(57) ABSTRACT

Fall-back prevention press of a crane in the form of a gas pressure cylinder, with a piston rod engaging in a cylinder space of the gas pressure cylinder configured as piston-type accumulator, with gas in the bottom space of the cylinder being in exchange with the gas in the piston rod and the ring space in surrounding relationship to the piston rod. A seal arrangement in a rod guide of the cylinder seals the piston rod against the cylinder. The seal arrangement includes a lubricant groove which extends around the rod guide and via which the piston rod is lubricated on the outside. The lubricant is acted upon by gas pressure prevailing in the cylinder with interposition of a pressure transmitter.

The invention relates to a fall-back prevention press of a crane according to the features of the first patent claim 1. Guying of a boom of cranes provides increase in load-bearing capability. The guying can be made via ropes or rods and has to be tracked to ensure reliable operation when the boom is in motion or when changing the boom angle and has to be maintained constantly under tension. An important element is the so-called recoil support.

According to the prior art, a hydraulic cylinder is attached to the recoil support and applies a pressure force from the boom to the recoil support to ensure defined force conditions in the guying even when the boom assumes a steep position. This hydraulic cylinder is referred to as a fall-back prevention press and may be designed as a plunger cylinder or differential cylinder. In some cases, this hydraulic cylinder is not connected to a central hydraulic system. Exchange of oil is provided by an external pressure accumulator as the cylinder moves.

An important feature of the fall-back prevention press is the pressure force/stroke characteristic. The latter is determined by the choice of accumulator type, its configuration and by the cylindrical geometry. This external accumulator takes up space and represents a high additional weight. Since the function of the fall-back prevention press is relevant as far as safety is concerned, the increased number of interfaces and connecting lines between cylinder and accumulator increases the risk of failure.

A known special design to avoid these added interfaces involves a hydraulic cylinder having a piston rod in which a piston-type accumulator with gas volume is integrated. The gas volume has to be slightly greater than the oil volume displaced by the stroke motion of the cylinder. As a result, the structural length compared to the hydraulic cylinder without accumulator is necessarily increased and therefore also the weight is increased. The extra weight may be less however when properly constructed than in the solution with external accumulator. For applications with limited length of the installation space, the provision of a further external gas tank next to the cylinder is sometimes necessary in addition to the accumulator integrated in the piston rod.

DE 27 33 528 B2 discloses a gas pressure cylinder in the form of a gas spring. Ring space and bottom space of the gas spring are in gas exchange with each other. A seal arrangement in a rod guide of the gas pressure cylinder seals the piston rod against the cylinder. In this design of a gas spring, a specific diameter reduction is to be provided on the piston rod to enable a filling of the gas spring with gas in the extended position of the piston rod. As a result, the pressure of gas filled in the cylinder can be reduced since during filling due to the extended position of the rod inside the cylinder, the maximal possible volume is already predetermined, i.e. not decreased by a retracted rod and therefore would have to be compensated by an excessive gas pressure.

DE 10 2004 017 405 A1 discloses as state of the art a pneumatic to open smoke and heat extraction flaps, wherein the piston rod is designed as accumulator. The piston rod has terminal end regions which project into the cylinder tube and have a closure in the form of a puncturable film. The puncturable film can be opened by a puncturing needle, so that compressed gas stored within the piston rod can escape from a cavity of the piston rod and exit the cylinder tube by a piston connected to the piston rod via the mentioned piston rod. The advantage is that the piston rod is at the same time an accumulator for a compressed gas which is required for moving out the piston rod in case of need. There is no need for an additional compressed gas accumulator which has to be connected to the pneumatic cylinders from outside.

The invention is based on the object to provide a fall-back prevention press for a crane, which is as compact and light as possible.

This object is achieved by a fall-back prevention press with the features of patent claim 1.

The fall-back prevention press according to the invention is based on a completely novel constructive concept with respect to such fall-back prevention presses. Instead of using a hydraulic cylinder with large oil volume and connected and/or integrated pressure oil reservoir, a precompressed, gas-filled cylinder is used. This has the advantage that no volume of oil must be exchanged during movement. Consequently, the weight of the oil and also the weight of the separating piston are eliminated when a construction with piston-type accumulator is involved.

As a result, overall a shorter installation space is attained with same compression force/stroke characteristic or a desired flatter compression force/stroke characteristic is attained at same installation length. The flattening of the compression force/stroke characteristic is due to the increase of the gas volume.

The fall-back prevention press according to the invention is characterized by the following features:
a) A piston rod engaging in a cylinder space of the cylinder is designed as a piston-type accumulator, with gas in the bottom space of the cylinder being in exchange with the gas in the piston rod;
b) A ring space of the cylinder in surrounding relationship to the piston rod is in gas exchange with the bottom space;
c) A seal arrangement in a rod guide of the cylinder seals the piston rod against the cylinder;
d) The seal arrangement includes a lubricant groove arranged circumferentially in the rod guide for lubricating the piston rod on the outside, with the lubricant being acted upon by gas pressure prevailing in the cylinder, with interposition of a pressure transmitter.

Lubrication of the piston rod and the rod-side guide and sealing elements is important for the wear and corrosion protection because is cannot be excluded that such cranes are sometimes in use for a very long in one place and because the extending piston rod is exposed to corrosion. It is therefore not sufficient to completely forego the use of lubricant in the actual application since lubrication must be provided. The invention now proposes that lubricant is acted upon, with interposition of a pressure transmitter, by the gas pressure prevailing in the cylinder. This has the advantage that lubricant, in particular oil, is needed exclusively for lubrication and corrosion protection so that a significantly smaller amount of oil is required than when a combined gas/oil cylinder is involved. Therefore, the use of high-grade and expensive oils with improved corrosion protection properties or improved low temperature properties can be made economical.

In addition, the use of proven sealing and guiding systems as well as piston rod coatings is still possible.

The construction without exchanging oil volume results in weight savings in the order of about 10%. There are also manufacturing advantages because there is no longer a need to treat the inside of the piston rod in view of the elimination of the internal separating piston. Moreover, the piston rod can be shortened.

As a result of the lower weight of the fall-back prevention press, installation is simplified and assembly costs are reduced. The fall-back prevention press according to the invention can be constructed with reduced weight and same characteristics compatibly with existing conventional support geometries so that a simple exchange is possible. For new constructions, shorter dimensions can be realized while maintaining the same compression force/stroke characteristic. A smaller mounting point distance with shorter installation dimension provides greater design freedom and thus affords the possibility to save additional weight in the area of the boom. At the same time, the stability of the piston rod is increased by the smaller mounting point distance.

According to an advantageous configuration of the invention, the pressure transmitter between the gas, which preferably involves nitrogen, is a separating piston. A separating piston allows the secure and reliable separation of gas and lubricant. Two possible embodiments are conceivable:

In the first embodiment, the separating piston may be a ring which is traversed by the piston rod. In this case, the separating piston is in the ring space of the gas pressure cylinder, while directly sealing against the piston rod. This design has the advantage that there are no external interfaces to external lubricant reservoirs, because all components involved in the lubrication are arranged within the gas pressure cylinder. Such a separating piston, which is formed by the ring traversed by the piston rod, requires a sealing on the outer circumference and the inner circumference in view of its own ring-shaped configuration.

Moreover, it is to be considered that a stop has to be placed anteriorly of the separating piston via which stop the completely extended piston rod is supported on the piston rod guide.

As an alternative, the separating piston is not configured as a ring but as a disk which is arranged in a distinct separating cylinder having a lubricant-filled space which is connected to the lubricant groove, and another space which is connected to the cylinder space of the gas pressure cylinder. This then involves a cylinder separate from the gas pressure cylinder which forms the fall-back prevention press.

As an alternative to separating pistons, it is also conceivable to use a flexible membrane as a pressure transmitter between the gaseous and liquid lubricant. Membranes have the advantage that no further peripheral seal is necessary.

An exemplary embodiment of the invention will now be described in greater detail with reference to the drawings. It is shown in:

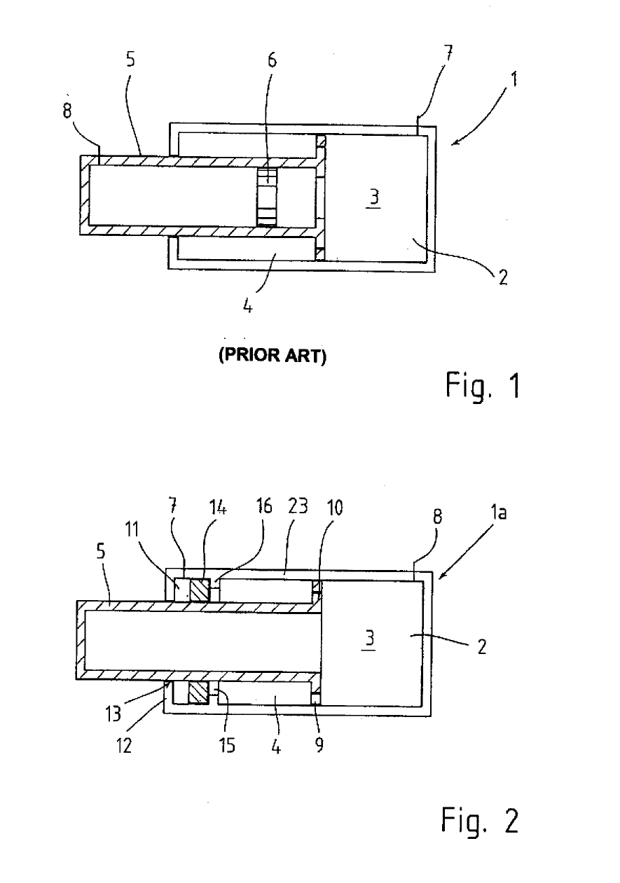

FIG. 1 a schematic illustration of a fall-back prevention press according to the prior art;

FIG. 2 a schematic illustration of a first embodiment of a fall-back prevention press according to the invention;

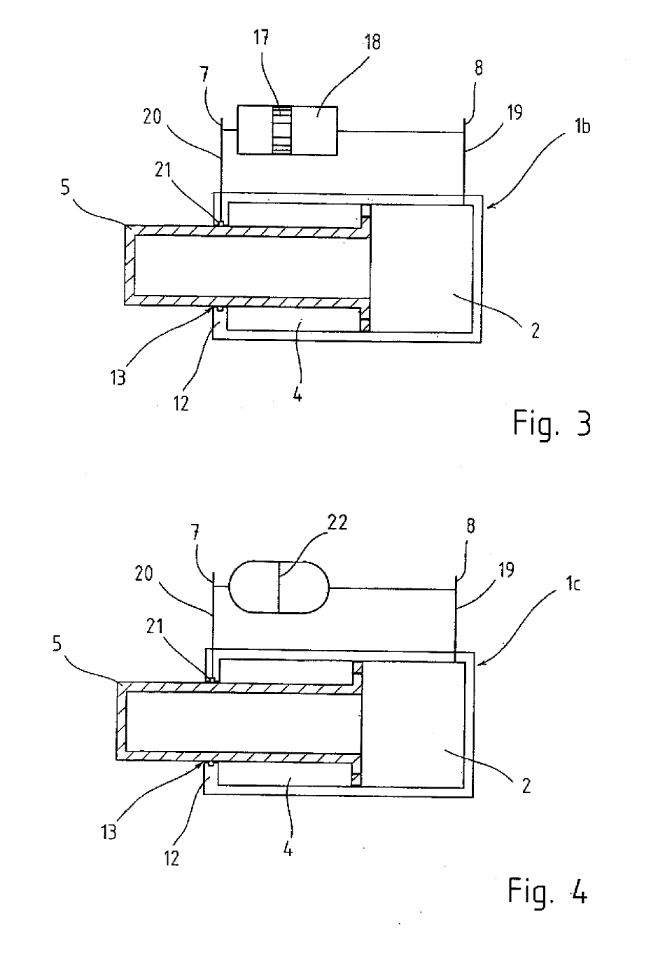

FIG. 3 a second embodiment of a fall-back prevention press according to the invention; and

FIG. 4 a third embodiment of a fall-back prevention press according to the invention.

FIG. 1 shows the prior art, i.e. a greatly simplified illustration of a fall-back prevention press 1. The fall-back prevention press 1 has a cylinder space 2 filled with oil. Oil is located in the bottom space 3 and in a ring space 4 which is traversed by the piston rod 5.

The piston rod 5 is constructed as a gas accumulator. A separating piston 6 within the piston rod 5 separates gas, in particular N2, located in the piston rod 5 from oil in the remaining areas of the fall-back prevention press 1.

The cylinder chamber 2 can be filled with oil via a port 7 at the bottom space 3. The interior space of the piston rod 5 can be filled with gas via a port 8 on the piston rod 5.

This arrangement has a relatively high weight in view of the used oil and the need for the separating piston to separate oil and gas. This variant has the disadvantage that the gas volume has to be slightly greater than the volume of oil displaced during the stroke motion. As a result, the structural length is increased and in turn weight is additionally increased.

FIG. 2 shows a first embodiment of the invention. The reference numerals as used in FIG. 1 are also used for substantially identical components. It can be seen that also in this case the piston rod 5, which projects into the cylinder space 2, is embodied as a piston-type accumulator. However, neither the bottom space 3 of the cylinder 2 nor the ring space 4, traversed by the piston rod 5, contains oil, but gas, in particular nitrogen. The piston rod 5 does also not include an internal separating piston but is in direct gas exchange with gas in the bottom space 3. The bottom space 3 is in gas exchange with the ring space 4 via through openings 9 in the piston 10 of the piston rod 5.

The special feature is the lubrication of the piston rod 5 by a very small amount of lubricant in the form of oil that is provided in a lubricant groove 11 in the area of the rod guide 12. The lubricant groove 11 is sealed by a seal arrangement 13 in the form of a sealing point against the environment. Inwards, i.e. in the direction towards the ring space 4, sealing or separation from gas in the ring space 4 is realized by a separating piston 14. The separating piston 14 is configured as a ring and sealed by a seal arrangement, not shown in greater detail, with respect to the piston rod 5 as well as circumferentially with respect to the cylinder 23. The separating piston 14 is acted upon by the gas pressure prevailing in the fall-back prevention press 1a, and thereby displaced in this exemplary embodiment to the left in the drawing plane. For this purpose, a further through opening 15 is provided in a stop 16 for support of the piston 10, when the piston rod 5 completely moves out. The lubricant groove 11 can be filled with lubricant and the cylinder space 2 can be filled with gas via ports 7 and 8, respectively.

The embodiment of FIG. 3 differs from the one of FIG. 2 in that the separating piston 17 is not configured as a ring in surrounding relationship to the piston rod 5, but is sealingly mounted as a disk or cylinder in a separate separating cylinder 18. The separating cylinder 18 is connected to the gas-filled cylinder space 2 of the fall-back prevention press 1b via lines 19, on one hand. On the other hand, the separating cylinder 18 is connected to the lubricant groove 21 in the guide rod 12 via a further line 20. In a manner not shown in detail, seal arrangements 13 are respectively provided to the side of the lubricant groove 21 to prevent escape of lubricant into the environment and into the ring space 4.

Lubricant and gas can be introduced via ports 7, 8 into the respectively provided regions of the fall-back prevention press 1b.

Instead of a separate separating cylinder 4, it is also possible to use a pressure transmitter 22 in the form of a membrane for the separation of the compressed gas from the lubricant, as shown in the embodiment of FIG. 4. This embodiment of a fall-back prevention press 1c has the advantage that the need for sealing elements which have to be provided about the circumference of the separating cylinder 18 to separate gas from lubricant is eliminated.

All other components of this arrangement have been described already with reference to FIG. 3. Reference is made to the preceding description.

Reference Signs:

1—fall-back prevention press

1a—fall-back prevention press

1b—fail-back prevention press

1c—fall-back prevention press

2—cylinder space

3—bottom space

4—ring space

5—piston rod

6—separating piston

7—port

8—port

9—through opening

10—piston

11—lubricant groove

12—rod guide

13—seal arrangement

14—separating piston

15—through opening

16—stop

17—separating piston

18—separating cylinder

19—line

20—line

21—lubricant groove

22—membrane

23—cylinder

1.-5. (canceled)

6. A fall-back prevention press of a crane, comprising:
a gas pressure cylinder having a rod guide and a cylinder space which includes a bottom space and a ring space;
a piston rod received in the cylinder space and configured as a piston-type accumulator in gas communication with the bottom space, said ring space of the gas pressure cylinder disposed in surrounding relationship to the piston rod and in gas communication with the bottom space;
a seal arrangement provided in the rod guide of the gas pressure cylinder to seal the piston rod against the cylinder, said seal arrangement including a lubricant groove arranged circumferentially in the rod guide for lubricating an outside of the piston rod; and
a pressure transmitter transmitting a gas pressure prevailing in the cylinder upon lubricant in the lubricant groove.

7. The fall-back prevention press of claim 6, wherein the pressure transmitter is embodied as a separating piston.

8. The fall-back prevention press of claim 7, wherein the pressure transmitter configured as separating piston is embodied as ring traversed by the piston rod.

9. The fall-back prevention press of claim 7, wherein the pressure transmitter configured as separating piston is embodied as a disk or piston which is arranged in a separating cylinder having a lubricant-filled space connected to the lubricant groove, and another space connected to the cylinder space of the gas pressure cylinder.

10. The fall-back prevention press of claim 6, wherein the pressure transmitter is configured as a flexible membrane.
